(19) United States
(12) Patent Application Publication
(10) Pub. No.: US 2005/0019148 A1
(43) Pub. Date: Jan. 27, 2005

(54) Method and apparatus for producing social stationery

(76) Inventors: Jonathan D. Sieber, Wayland, MA (US); Joseph S. Sieber, Weston, MA (US)

Correspondence Address: Jamie H. Rose;Wolf, Greenfield & Sacks, P.C., 600 Atlantic Avenue, Boston, MA, 02210, US

(21) Appl. No.: 10/846,010

(22) Filed: May 14, 2004

Related U.S. Application Data
(60) Provisional application No. 60/471,376, filed on May 16, 2003.

(51) Int. Cl. B65G 57/00; B26D 7/00; B65H 39/02; B42C 7/00; B42B 5/08

(52) U.S. Cl. 414/790.2; 414/802; 83/650; 270/58.1; 270/58.08; 412/3; 412/7; 412/38

(57) ABSTRACT

A method for producing an article having a surface feature, such as an article of social stationery, includes defining a characteristic of at least one layer of the article of social stationery, and displaying an image associated with the at least one layer to permit reviewing of the defined characteristic of the at least one layer. A production apparatus includes a computing system configured to implement methods for designing and fabricating articles for the particular needs of a retail customer. An article can include features that conceal or camouflage holes that support attachment of components of the article.

### RELATED APPLICATIONS

This application claims priority under 35 U.S.C. § 119(e) to U.S. Provisional Application Ser. No. 60/471,376, entitled “Method and Apparatus for Producing Social Stationary,” filed on May 16, 2004, which is herein incorporated by reference in its entirety.

### BACKGROUND OF INVENTION

1. Field of Invention

The invention relates to articles having surface designs, and, more particularly, to methods and apparatus for retail merchandising and fabrication of articles having surface designs.

2. Discussion of Related Art

Articles having surface design features, such as social stationery, have traditionally been provided to consumers as pre-printed articles. Social stationery, for example, which is available at retail stores such as card shops or party supply retailers, may also be provided using an on-demand production facility through which the consumer can select from various colors, patterns, themes, or images, arrange these elements according to their desire, and then have their desired arrangement printed on-demand. Social stationery, for example, includes, but is not limited to, greeting cards, get-well cards, birthday or anniversary cards, thank you notes, invitations (including enclosures, such as RSVP cards), dinner seating place cards, napkins, envelopes, decorations (such as banners,) stationery, table cloths, etc.

On-demand social stationery production facilities provide the consumer with a myriad of design options that are frequently overwhelming. Further, because of this potentially unlimited choice of colors, patterns, etc., consumers may spend a great deal of time designing their desired finished article of, for example, social stationery, only to find out that their design is esthetically unpleasing when produced.

### SUMMARY OF INVENTION

The invention arises in part from the realization that inventory inefficiencies and choice limitations in prior approaches to retail sales of articles, such as articles of social stationery, can be remedied via point-of-sale methods and systems that permit retail customers to design desired articles and to fabricate articles, in a desired quantity, at a retail establishment. Principles of the invention can be applied to sales of a variety of articles that include surface design features, such as, but not limited to, wallpaper, posters, and flooring products. The invention also arises, in part, from the realization that holes, used in the assembly of components of articles of social stationery, can be hidden through pattern matching and/or attachment components that conceal holes.

According to one aspect of the present invention, a method and apparatus provide for in-store, on-demand production of articles having surface design features, such as articles of social stationery. In one embodiment, an in-store, on-demand social stationery production facility is described that can be used to produce social stationery. Although the production facility provides a myriad of design options, which can be individually tailored by a consumer to design an article of social stationery, design elements are grouped, selected, and applied in a manner that reduces the time and complexity of the design process, and increases the likelihood that the final design will be aesthetically pleasing to the consumer. The production facility may be used to produce a variety of types of social stationery, including cards, invitations or stationery, decorations, envelopes and envelopes with lining, and accessories such as decorative overlays.

In one embodiment, according to principles of the invention, a method for producing an article of, for example, social stationery includes defining a characteristic of at least one layer of the article of social stationery, and displaying an image associated with the at least one layer to permit reviewing of the defined characteristic of the at least one layer. In response to a determination that a user desires modification of the defined characteristic, the method can also include repeating the acts of defining and displaying until the user is satisfied. The method can also include assembling the article of social stationery at least in part by applying the at least one layer to at least one component of the article of social stationery.

The one layer can be, for example, ink having a pattern. The component can be, for example, a sheet of a medium, such as a sheet of paper.

In another embodiment, according to principles of the invention, a production apparatus, for example, a social stationery production apparatus, includes a computing system configured to implement the above-described acts of defining, displaying, and repeating. The apparatus also includes a printer configured to print the at least one layer on at least one component of the article of social stationery. The apparatus can be placed in a retail establishment to facilitate a customer's selection process, and to fabricate a desired quantity of articles.

According to another aspect of the present invention, methods of merchandizing articles, such as articles of social stationery, are described. Advantageously, the methods may be used to facilitate the operation and use of the in-store, on-demand social stationery production facility discussed above.

According to yet another aspect of the present invention various methods for attaching a first layer of an article of social stationery to a second layer are provided. Advantageously, the methods may be used to reduce the visual impact or conceal the presence of holes in the first layer when used to attach the first layer to the second layer.

In one embodiment, according to principles of the invention, a method for assembling an article of social stationery includes providing first and second components of the article of social stationery, where the first component has at least one hole for use in attaching the components to one another. The method also includes providing an overlay, such as a strip of material. The first component is then disposed between the second component and the overlay, and the overlay is attached to a portion of the second component exposed through the hole in the first component. The overlay can thus partially or completely conceal the hole in the first component.

In another embodiment, a method for assembling an article of social stationery includes providing first and second components of the article of social stationery. Each of the two components has a hole for use in attaching the components. The hole through the second component has a smaller area than the area of the hole through the first component. The second component has a visible feature surrounding the hole. The visible feature matches a visible feature surrounding the hole in the first component. The method includes attaching the first and second components so that the hole in the first component overlaps the hole in the second component. The visible features surrounding the first and second holes match each other to provide a camouflaging effect that tends to conceal the hole in the first component.

Other advantages, novel features, and objects of the invention, and aspects and embodiments thereof, will become apparent from the following detailed description of the invention, including aspects and embodiments thereof, when considered in conjunction with the accompanying drawings, which are schematic and which are not intended to be drawn to scale.

In the figures, each identical or nearly identical component that is illustrated in various figures is represented by a single numeral. For purposes of clarity, not every component is labeled in every figure, nor is every component of each embodiment or aspect of the invention shown where illustration is not necessary to allow those of ordinary skill in the art to understand the invention.

### BRIEF DESCRIPTION OF DRAWINGS

The accompanying drawings, are not intended to be drawn to scale. In the drawings, each identical or nearly identical component that is illustrated in various figures is represented by a like numeral. For purposes of clarity, not every component may be labeled in every drawing. In the drawings:

FIG. 1 is a flowchart illustrating a method for producing social stationery according to an embodiment of the present invention;

FIG. 2 is a flowchart illustrating a number of acts that may be performed in defining a product in accordance with the flow chart of FIG. 1;

FIG. 3 is an exemplary on-demand social stationery production facility that may used in accordance with the present invention;

FIG. 4 illustrates a method of attaching one layer of an article of social stationery to another to form a finished article of social stationery according to one embodiment of the present invention; and

FIG. 5 illustrates a method of attaching one layer of an article of social stationery to another to form a finished article of social stationery according to another embodiment of the present invention.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Depending on context, the word “layer” is used herein to refer either to a feature, for example, a surface design feature, added to a component of an article, or to the component itself. For example, the word “layer,” can refer to a sheet having a printed pattern of ink of one or more colors, or to the printed pattern of ink on the sheet, or, for example, to a pattern embossed on a component, such as a component of flooring. Thus, for example, a layer of ink can be applied to a component sheet of paper. The completed sheet of paper can then be referred to as a layer of an article. Also, more than one layer of, for example, ink can be applied to, for example, a single component, such as a sheet of paper.

In accordance with one aspect of the present invention, methods and apparatus for producing an article of social stationery are provided. In overview, one method relating to this aspect of the invention includes designing one or more layers of an article of social stationery, such as a card or invitation, that may either be separately printed on a sheet of paper, card-stock, or other media, and then finished in a desired arrangement of layers to form a finished article of social stationery, or in which a desired arrangement of layers may be combined and printed on a single sheet of paper, card-stock, or other media in a manner in which the arrangement of layers as separate sheets of paper, card-stock, or other media is visually simulated to form a finished article of social stationery.

It will be understood that features of the invention can be applied to a wide variety of articles beyond that of articles of social stationery. For simplicity, the below described embodiments focus on examples relating to social stationery. These examples, however, are not intended to be limiting. More generally, articles that, for example, have surface design features can benefit from application of principles of the invention.

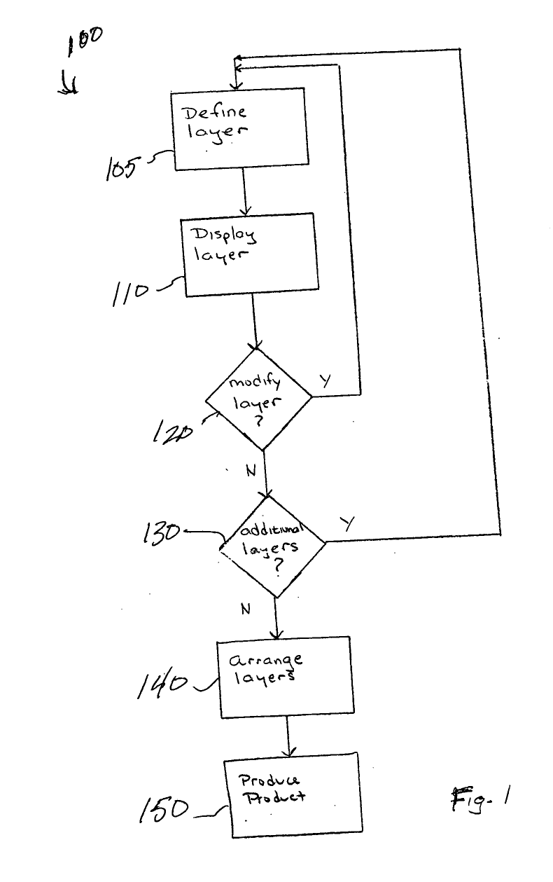

FIG. 1 is a flowchart illustrating a method 100 for producing an article of social stationery according to one embodiment of the present invention. It should be appreciated that the present invention is not limited to the specific embodiments herein described, as numerous alterations and modifications will be apparent to those of ordinary skill in the art. In one embodiment, the method 100 may be encoded on a computer readable medium that is executed on a processor of a computer-based, on-demand, social stationery production facility, as described further in detail below.

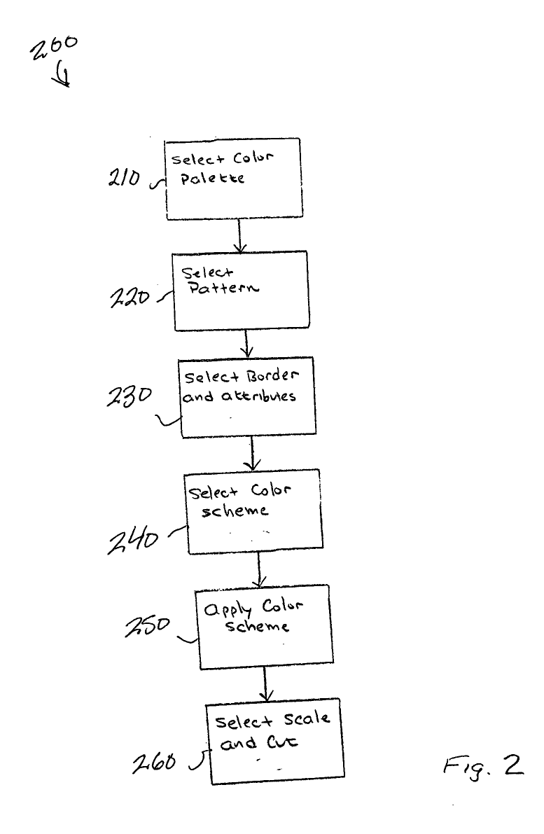

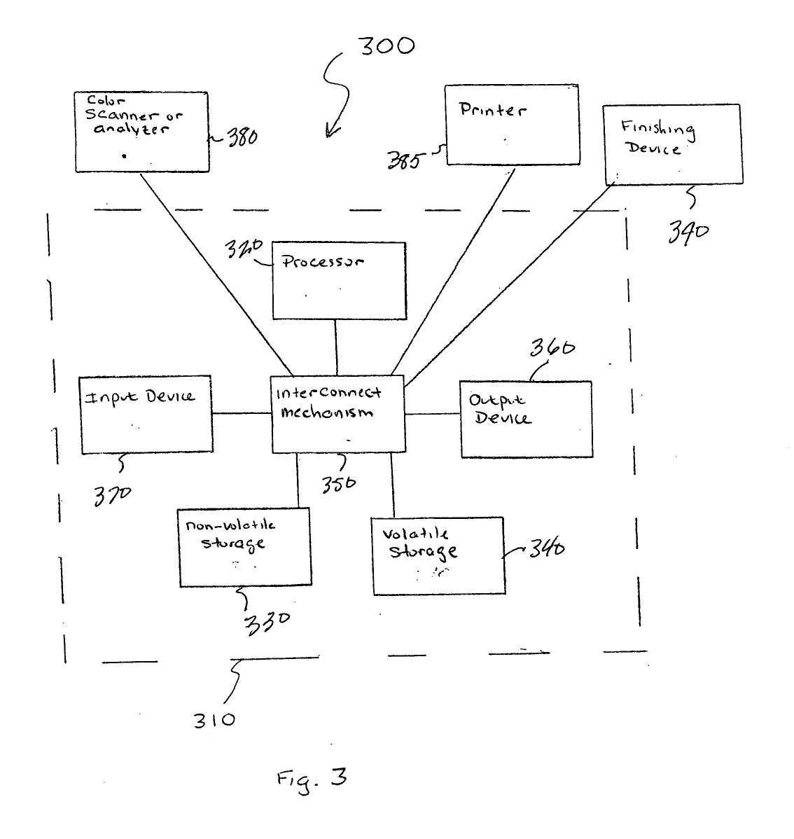

In act 105, a user interacting with an on-demand social stationery production facility (see FIG. 3) defines a characteristic of a layer that will be used to form an article of social stationery. The characteristic of the layer can be defined by selecting various design elements and applying the selected design elements to the layer that will be used to form the article of social stationery. Details of the manner in which a characteristic of a layer can be defined in act 105 are described further below with reference to FIG. 2.

In act 110, the layer whose characteristic was defined in act 105 is displayed in a manner that permits the user to visually perceive that layer. This act of displaying may be performed, for example, by rendering an image of the layer on a display screen of the computer system that forms a part of the on-demand production facility, by printing a sample of that layer on an appropriate medium, or both. The defined characteristic of the layer can thus be reviewed by, for example, a retail customer utilizing the production facility. It should be appreciated that because a computer display screen is frequently incapable of rendering a faithful reproduction of the layer defined in act 105, the ability to print a sample provides immediate feedback to the user on how the layer will actually look in the finished article of social stationery.

After displaying the layer, the method 100 proceeds to act 120, wherein a determination is made as to whether modification of the designed layer is desired by the user, based upon his or her review of that layer displayed in act 110. If it is determined that modification is desired, the method 100 returns to act 105. Alternatively, when it is determined that modification is not desired (i.e., the user is satisfied with the design of the layer), the method 100 proceeds to act 130, wherein a determination is made as to whether additional layers are to be defined that may be used to form the finished article of social stationery. It should be appreciated that many types of social stationery (for example, a simple thank you note) may not include multiple layers, such that act 130 is optional and need not be performed in all circumstances.

When it is determined, in act 130, that additional layers are desired, the method 100 returns to act 105, wherein acts 105-120 are performed with respect to the additional layer(s). Alternatively, when it is determined in act 130 that either no additional layers are desired, or that all additional layers have been defined, the method 100 proceeds to act 140.

In act 140, the various layers defined in acts 105-130 are arranged and aligned according to selections performed by the user. For example, in act 140 the user may be prompted to indicate whether the various layers that will be used for the finished article of social stationery are to be printed on separate sheets of paper, card-stock, or other media, or whether the various layers that will be used for the finished article of social stationery are to be printed on the same sheet of paper, card-stock, or other media.

If the user indicates that the various layers that will be used to form the finished article of social stationery are to be printed on separate sheets of paper, card-stock, or other media, the user is provided with the ability to specify which layers will be on top of one another (i.e., an order for the components of the article), how those layers are to be aligned relative to one another (e.g., centered, offset, etc.), how those layers interact with one another, etc.

For layers that are partially covered by another layer, the user may be provided with the ability to “knock-out” or remove that portion of the pattern or image that is covered by another layer. It should be appreciated that where a layer is partially covered by another layer that is opaque, this ability to “knock-out” the covered portion can result in a significant savings of ink, toner, or other marking material that is used to create the image or pattern. Alternatively, where a layer is partially covered by another layer that is at least partially transparent (for example, by vellum), the user may desire not to “knock-out” the covered portion of the lower layer, so that the pattern of the lower layer is visually apparent through the overlying layer. It should be appreciated that where separate sheets of media are used to form the various layers, crop marks may also be provided (preferably in a manner such that they are obscured by the overlying layer) to guide the alignment of one layer to another in the finished article of social stationery.

Alternatively, if the user indicates that the various layers that will be used to form the finished article of social stationery are to be printed on the same sheet of paper, card-stock, or other media, the user is provided with the ability to specify which layers will be on top of one another and how those layers will be aligned (e.g., centered, offset, etc.), as well as with the ability to specify the shading that is applied to the various layers to simulate separate sheets of paper, card-stock, or other media, and their thicknesses.

It should be appreciated that the present invention is not limited to the above described arrangement of layers, as the user may also be provided with the ability to specify that two or more layers be formed on the same sheet of a medium, while one or more other layers each be formed on a different sheet. Moreover, it should also be appreciated that where the finished article of social stationery includes only a single layer, then the act of arranging layers may be omitted.

After specifying the desired arrangement of layers, the product is assembled by applying the selected one or more layers to selected one or more component parts of the article. For example, in act 150, assembly can begin by sending the appropriate commands to a printer. It should be appreciated that once the design of the finished article of social stationery is determined, any number of copies of the finished article may be produced, on-demand, by the user.

Although not depicted in the flowchart of FIG. 1, additional acts may also be involved in completing the finished article of social stationery. For example, there may be acts of physically cutting the various layers to size (for example, if a particular size of media is not readily available), acts of applying an adhesive (where the media is not provided with an adhesive layer), or acts of adhering or otherwise attaching the various layers to one another. Moreover, additional acts such as defining accessories (for example stick-on images, graphics, or patterns) that coordinate with the finished article of social stationery may also be performed, as discussed further in detail below.

FIG. 2 is a flowchart illustrating a method 105a, according to principles of the invention, which includes various acts 210-260 that may be performed during the act 105 of defining a layer of an article of social stationery, discussed above with respect to FIG. 1. As will be described in detail further below, the order in which the acts are performed may be different from that illustrated in FIG. 2, and thus, the present invention is not limited to the specific ordering of acts illustrated therein.

In act 210, the user is prompted to select a color palette, typically from a set of defined color palettes. In general, the color palettes from which the user may select one or more color palettes represent shades of colors. For example, each color palette may represent a particular color, such as burgundy, with a range of shades or tones of the color burgundy being shown. Typically, there might be four or more colors (e.g., the same color but at differing degrees of contrast and intensity) in each color palette, and each color palette may often also include white (for example, to be used for a “knock out” text, as discussed further below). These color palettes may, for example, represent colors selected by the Color Board (a group that selects particular colors for a particular model year, which are used by manufacturers, such as appliance manufacturers, to ensure coordination amongst different manufacturers.)

Alternatively, these color palettes may represent colors that are, for example, based upon a theme, such as red, white, and blue for independence day, green and red for Christmas, or a variety of pastel colors for Easter, etc. In general, each color palette represents colors, tones, or hues of colors that may be used with one another in a pleasing fashion, or to convey a particular theme.

It should be appreciated that the present invention is not limited to a particular color palette, or set of color palettes. Indeed, according to one embodiment, discussed in detail further below, the set of color palettes may include one or more color palettes that are created based upon input from a user. For example, a color analyzer or color scanner may be used to input colors from a sample (e.g., a table cloth, a napkin, or other type of color swatch) provided by the user. Based upon that sample, a series of color palettes featuring differing shades or hues of colors present in that sample may be formed and used to create an article of social stationery that coordinates with that sample. Alternatively, color palettes that include colors that complement colors in the sample may also be provided.

In one embodiment of the present invention, a selection of suggested palette groupings may be displayed for selection by the user. For example, individual color palettes in the suggested palette groupings may be used to form different layers of an article of social stationery to achieve a coordinated appearance.

After selecting a color palette in act 210, the user is prompted to select a pattern, in act 220, from a set of various patterns, which can later be applied to the selected color palette or palettes. In general, each pattern specifies an image, a texture, etc. that is independent of any particular color palette. For example, a polka dot, a fish-scale, or a fleur-de-lis pattern could be selected, wherein the color of the background and foreground of the polka dots, fish-scales or fleur-de-lis pattern is yet to be defined. In general such patterns will typically be represented by two colors (selected from the color palette selected in act 210, although the present invention is not so limited, as more than two colors may also be represented). After selecting one or more patterns in act 220, the routine proceeds to act 230.

In act 230, the user is prompted to select a border from a set of borders. The border defines the area in which the pattern selected in act 220 will be applied to the selected layer based upon the selected color palette. The border selection defines the inner and outer shape or boundaries of the border, and also defines how the border interacts with the pattern. For example, the shape of the border may be symmetrical, such that the inner and outer boundaries of the border are both square, round, or rectangular. Alternatively, the border may have a more complex shape, such that the outer boundary defines a square or a rectangle, while the inner boundary defines a different shape, such as circle or an oval (e.g., similar in effect to a square or rectangular matte with a circular or oval cut-out to receive a picture or photograph.)

Alternatively still, the outer boundary, the inner boundary, or both the outer and inner boundaries of the border may give the over-all impression of a rectangle, square, circle, oval, or other shape, but be ragged in appearance. It should be appreciated that the selection of the border is independent of any particular color palette, and may be applied to any color palette.

The selection of a border in act 230 may also include selecting attributes that will be applied to the selected border. These attributes determine how the pattern selected in act 220 interacts with the border selected in act 230 (i.e., how the border will be overlaid on the pattern to create a writable area.) For example, to make the process easier for the user, the selection of a border may include a default selection that specifies that the pattern selected in act 220 will be applied between the inner and outer boundaries of the border. Such an application permits the region inside of the inner boundary of the border to be capable of being written upon by the user, as the pattern selected in act 220 is effectively masked out in this region. The user may be provided, however, with the ability to define the attributes of the border differently, such that the pattern is not applied to the border itself (i.e., the area between the inner and outer boundaries of the border), but only to the region inside the inner boundary of the border.

It should be appreciated that although a border is generally desirable to many users, the act of selecting a border is optional, and the present invention is not limited to the selection of a border or to a particular type or interaction between the border and the pattern. It should also be appreciated that other manners of selecting a border may be provided, for example, to accommodate users seeking a more complex design. For example, the border itself may be provided with the ability to have a pattern applied thereto that may be different than the pattern selected in act 220. However, it should be appreciated that to avoid burdening the user with an overwhelming array of choices and options, certain default selections may be provided (e.g., a default selection in which the pattern is applied to the border within the inner and outer boundaries,) with a provision to permit a user to over-ride the default selection, if desired.

In act 240, the user is prompted to select a color scheme from a set of color schemes that define how the selected color palette is to be applied to the pattern and to the border, if one has been selected in act 230. The set of color schemes may include tones in a selected color palette on a white background, tones in a selected color palette as a background with a foreground of white or a white pattern, or tones in a selected color palette on other tones of the same or a different palette.

In general, the various sets of color schemes are determined in advance by an artist having an appreciation of how various tones, intensity, or hues of colors may be combined to form an aesthetically pleasing appearance, although the present invention is not so limited, as discussed further below. For example, one color scheme may reflect a combination of high contrast, high intensity colors selected (typically in advance by an artist) from the user's color palette selected in act 210. Such a selection of high contrast, high intensity colors would be appropriate where the user desired a layer of vellum to be placed over the selected pattern, such that the pattern would slightly show through the vellum in the finished article (i.e., the pattern beneath the vellum layer would be discernable, but highly subdued), but the vellum overlay would be capable of being written upon in a manner in which the writing would be clearly discernable. In this example, the ink, toner, or other marking material used to create the textual matter of the article of social stationery may also be selected from the user's color palette selected in act 210.

Another color scheme may reflect a combination of low contrast, low intensity colors selected from the user's color palette selected in act 210. Such a selection of low contrast, low intensity colors would be appropriate where the pattern was to be applied to the area adapted to receive written text. In such a selection, a high intensity high contrast color selected from the user's color palette in act 210 may be used for the written text.

Yet another color scheme may reflect a combination of low contrast, high intensity colors chosen from the user's color palette selected in act 210. Such a selection would be appropriate where the pattern was to be applied to the area adapted to receive written text, wherein the text would be “knocked out” of the background pattern (i.e., the textual characters would be defined by the absence of the pattern.) Each of these color schemes may be used to create an aesthetically pleasing design for an article of social stationery, although it should be appreciated that the present invention is not limited to any particular color scheme, or the combination of color schemes discussed above and described in further detail below.

After selecting a color scheme, in act 250, the selected color scheme is applied to the pattern or to the pattern of the border if one was selected in act 230. Although the act of applying the color scheme is described as a separate step, it should be appreciated that the present invention is not so limited, as the color scheme may be applied to the pattern or to the pattern of the border upon the selection of the color scheme in act 240.

After applying the color scheme in act 250, the routine proceeds to act 260, wherein the user is prompted to select the desired scaling and cutting that will be applied to the selections made in acts 210-240. Several examples will clarify what is meant by the terms scaling and cutting. For example, if the user had selected a leopard pattern in act 220 to be applied to a border selected in act 230, the user would be requested to select the desired scaling applied to the leopard pattern, so that the darker spots on the lighter background are aesthetically pleasing, given the size of the particular layer. One should appreciate that if the particular layer was small in size, a large scale might make the leopard pattern unrecognizable (i.e., a few dark blotches seemingly randomly arranged from which the leopard pattern is itself nearly or totally unrecognizable.)

In act 260, the user is also requested to select the desired cutting that is applied to the selections made in acts 210-240. The term cutting refers to how the pattern is oriented on the particular layer. In the example of the leopard pattern being applied to a border, for example, it may be desirable to have the pattern begin and end in the lighter color defining the edges of the border, such that only complete darker spots (i.e., not a truncated portion of a darker spot) are present within area defining the border. Alternatively, where the pattern is an alternating pattern of lighter and darker vertical stripes (e.g., a zebra-like pattern,) and that pattern is applied to the border, then it may be desirable to have that pattern begin and end in a darker stripe, or, alternatively to begin and end in a symmetric portion of a darker stripe.

In general, the process of cutting is analogous to the process of tiling a floor, whereby one typically orients the tiles so that no wall is adjacent to less than one half a tile. This may result in some adjustment in the alignment of the tiles (e.g., so that a tile is centered in the middle of the room, or so that a gap between two tiles is centered in the middle of the room.)

Although the process of defining a layer of an article of social stationery has been described above with respect to FIG. 2, it should be appreciated that the present invention is not limited to the particular sequence of acts, or to the presence of all the acts depicted therein. For example, because the pattern selected in act 220 and the border selected in act 230 are each independent of the selected color palette, either or both of these acts may be performed prior to the selection of a color palette in act 210. Alternatively or additionally, the order in which acts 220 and 230 are performed may be reversed. Similarly, the act of selecting a color scheme may be performed prior to either the act of selecting a pattern or selecting a border, such that upon selection of the pattern or border, the color scheme may be automatically applied.

Similarly, numerous alterations, modifications, and additions may be made with respect to the method described with respect to FIG. 1. For example, in addition to various selections discussed above with respect to the act of arranging layers (i.e., act 140 in FIG. 1), other selections may be provided. For example, the user may be prompted as to whether he or she desires to soften the interaction of the various layers by, for example, adjusting the color scheme at the edges of a layer. For example, the intensity of a border pattern may be reduced to create a fading of the pattern, or to gradually merge with the color scheme of a different layer.

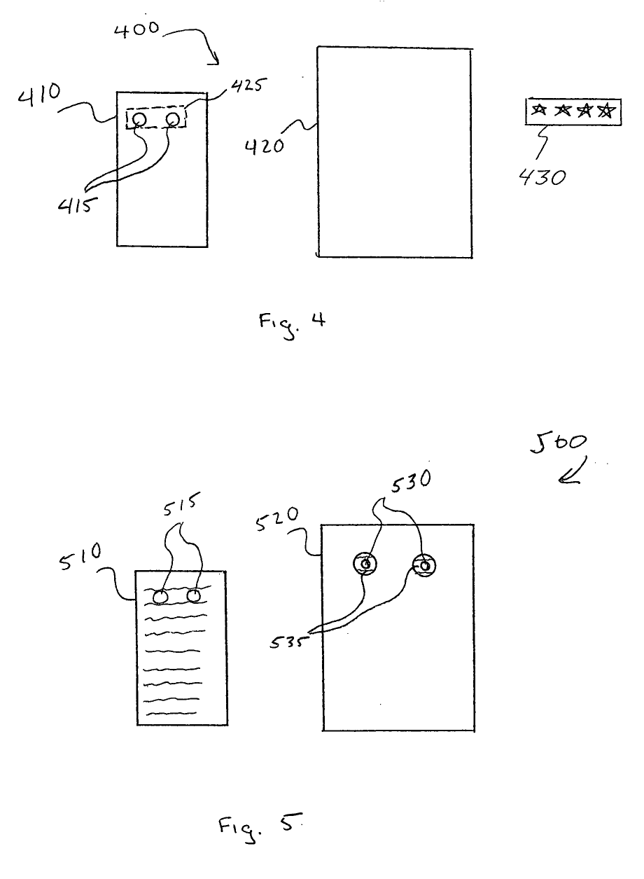

Further, as discussed above, the method 100 of producing an article of social stationery described with respect to FIG. 1 may include additional acts. For example, after acts 105-150, the user may be queried as to whether they desire any accessories, such as overlays. The accessories may be based upon fixed color art graphics or patterns having a fixed color scheme and/or color palette (for example red and white candy canes) or they may have a variable color scheme and/or color palette. For example, where the accessories do not have a fixed color scheme and/or palette, one or more of the color schemes selected by the user in act 240 (FIG. 2) or palettes selected in act 210 may be applied to the accessory.

Where the accessory is intended to be used for an overlay as discussed further below with respect to FIG. 4, the color palette, pattern and color scheme of the overlay may be selected to be the same as that used in the layer on which it is overlaid. Alternatively still, some portion of the accessory may be fixed, while others may be modified to coordinate with one or more layers of the finished article of social stationery.

According to another embodiment of the present invention, an on-demand social stationery production facility is now described which may be used to implement the methods described above in FIGS. 1-2.

As shown in FIG. 3, the on-demand social stationery production facility 300 includes a general-purpose computer system 310 which may be based on an Intel PENTIUM-type processor, a Motorola PowerPC processor, a Sun UltraSPARC processor, a Hewlett-Packard PA-RISC processor, or any other type of processor or processors. As illustrated in FIG. 3, the general-purpose computer system 310 typically includes a processor 320 connected to one or more non-volatile memory storage devices 330, such as a disk drive, a tape drive, a diskette drive, a CD ROM drive, etc., or more typically a combination of such non-volatile memory storage devices. The general-purpose computer system 310 also typically includes some form of volatile memory storage 340, such as RAM that is connected to the processor 320. Memory 330 is typically used for storing programs and data that, during operation of the computer system 310, is loaded into volatile memory storage 340 and executed or operated upon by the processor 320.

The above-described components of the computer system 310 may be coupled by an interconnection mechanism 350, which may include one or more busses (e.g., between components that are integrated within a same machine) and/or a network (e.g., between components that reside on separate discrete machines.) The interconnection mechanism 350 enables communications (e.g., data, instructions) to be exchanged between the components of system 310.

Computer system 310 also includes one or more output devices 360, for example, a display screen, and one or more input devices 370, for example, a keyboard, mouse, or trackball. Other input or output devices such as microphones, joysticks, and speakers may also be provided. Preferably, the display screen is capable of rendering accurate representations of color, such that during operation of the on-demand social stationery production facility 300, users are provided with an accurate representations of the finished article of social stationery or portions thereof. In addition to the foregoing, the computer system 310 may contain one or more interfaces (not shown) that connect the computer system 310 to a communication network (in addition or as an alternative to the interconnection mechanism 350.)

In addition to the general-purpose computer 310, the on-demand social stationery production facility 300 also includes one or more printers 385, such as a color laser printer or an ink jet printer, although many other types of printing technology may alternatively be used (e.g., dye sublimation printers, thermal transfer printers, etc.) In general it should be appreciated that a relatively high resolution printer (e.g., 600 by 600 dots per inch (dpi) or better) is preferred. Moreover, it should be appreciated that more than one type of printer 385 may be provided. For example, one type of printer may be specifically suited for printing on heavy weight paper and card stock, while others are specifically suited for other types of media, such as envelopes, or for lighter weight media.

According to one embodiment, the on-demand social stationery production facility 300 may also include a color scanner or analyzer 380, or both. The presence of a color scanner or color analyzer may be used to permit a user to scan in a sample element (e.g., a portion of a table cloth, a napkin, a particular decoration, a color swatch, etc.) for an event, from which one or more custom color palettes may be generated as discussed above.

According to another embodiment, the nonvolatile memory storage device 330 may be used to distribute additional color palettes, patterns, or borders that may then be accessed by a user. Alternatively, such additional color palette, patterns or borders may be copied via a network (e.g., the internet) for use.

Although computer system 300 is shown by way of example as one type of computer system upon which various aspects of the invention may be practiced, it should be appreciated that aspects of the invention are not limited to being implemented on the computer system as shown in FIG. 3. Various aspects of the invention may be practiced on one or more computers having a different architecture or components that that shown in FIG. 3.

Various embodiments of the present invention, such as the methods described above with respect to FIGS. 1 and 2 may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

According to another aspect of the present invention, some embodiments of methods of merchandising articles of social stationery are now described. Advantageously, the methods may be used to facilitate the operation and use of the in-store, on-demand social stationery production facility 300 discussed above.

According to one method, a merchandizing display is provided in which there are decks of different colors and patterns that may be provided that can be mixed with one another to simulate various selections that may be achieved using the social stationery production facility described above. For example, a number of different transparencies featuring various patterns may be place on top of various color samples to provide an idea of how a particular pattern will look with a particular color. Other transparencies may be provided to illustrate the look of different borders, with portions of the border being transparent and others being opaque.

Alternatively, a sample book may be provided, for example with input from an artist or graphic designer that illustrate some of the more popular combinations of color palettes, patterns, borders, and color schemes. The sample book may additionally show options for accessories and how various colors coordinate. The sample book may also illustrate how various layers may be overlaid with one another.

Still alternatively, a rack display may be provided that illustrates various layers that can be written upon which may be purchased for incorporation into a finished article of social stationery. In addition, the rack display may also include various layers, such as borders that may be purchased for incorporation into a finished article of social stationery. Advantageously, the various layers may be displayed with the patterns grouped and the colors schemes grouped, and the color pallets grouped for ease of shopping.

It should be appreciated that the above described merchandizing methods may be used in any retail establishment wherein the on-demand social stationery production facility may be located for one-stop shopping.

According to another aspect of the present invention, embodiments of methods for attaching a layer of an article of social stationery to another layer are provided, as now described with reference to FIGS. 4 and 5.

In many instances, one layer of an article of social stationery is attached to another layer using a decorative ribbon or a clip. For example, frequently a set of two adjacent holes are provided in each layer, the holes are aligned with one another, and a ribbon or clip is passed through the aligned holes. The ribbon or clip may be secured in front of the upper layer, or behind the lower layer, depending on the effect desired. Generally, the holes are sufficiently larger than the ribbon or clip to allow easy insertion without tearing or otherwise distressing the media from which the layers are formed. The size of the holes, however, negates the aesthetic effect of the ribbon or clip, such that the holes are clearly visible even with the ribbon or clip in place.

According to one embodiment of the present invention, a method for attaching a first layer of an article of social stationery to a second layer includes acts of forming at least one hole in a first layer, aligning the first layer with the second layer, and applying an adhesive backed overlay to conceal the at least one hole such that the adhesive backed overlay contacts the second layer. This embodiment is now described with respect to FIG. 4.

FIG. 4 illustrates an article of social stationery 400 formed from two different layers 410, 420, and secured with an adhesive backed overlay 430. As shown, the first or upper layer 410 is preferably formed from a relatively thin or lightweight medium, such as vellum. One or more holes 415 are then formed (for example, with a punch) in the first layer 410 in a desired location, dependent upon the manner in which the first layer is to be affixed to the second layer 420. For example, rather than the two holes 415 shown in FIG. 4, two pairs of holes could be provided at the top and bottom of the first layer.

After formation of the one or more holes, the first layer 410 is aligned with the second layer 420 in a desired manner (e.g., centered,) and an overlay 430 is then applied to the region indicated at 425 and pressed firmly in place. Preferably, the overlay 430 includes an adhesive backing, such that a separate act of applying an adhesive to the back of the overlay is avoided. Advantageously, the overlay may be printed with a color scheme and/or pattern that coordinates with the design of the finished article of social stationery.

It should be appreciated that in the above described embodiment, the hole(s) should be of sufficient size to permit the adhesive backed overlay 430 to secure the first layer 410 to the second layer 420. Further, although the act of aligning the first layer 410 with the second layer 420 was described as being performed prior to application of the overlay 430, the present invention is not so limited. For example, the overlay 430 could be applied to the first layer 410 in the desired location, and then the first layer 410 aligned with the second layer 420 in the desired manner and then pressed firmly in place.

According to another embodiment of the present invention, another method of attaching a first layer of an article of social stationery to a second layer is now described with reference to FIG. 5. According to this embodiment, the method includes steps of forming at least one first hole having a first area in a first layer, forming at least one second hole having a second area in the second layer, the second area being less than the first area and being surrounded by a region having a third area that is substantially equal to or greater than a difference between the first and second areas and imprinted to coordinate with printing on the first layer, and passing a retaining member through the at least one first hole and the at least one second hole to attach the first layer to the second layer.

FIG. 5 illustrates an article of social stationery 500 formed from two different layers 510, 520, that may be attached to one another with a retaining member, such as a ribbon, bow, or clip. As shown, one or more holes 515 are then formed (for example, with a punch) in the first layer 510 in a desired location, dependent upon the manner in which the first layer is to be affixed to the second layer 520. One or more holes 530 are also formed in a similar manner in the second layer 520 in a desired location.

The holes 530 in the second layer have an area that is smaller than the area of the holes 515 in the first layer 510, and they are disposed to align with the holes 515 in the first layer. Surrounding the holes 530 in the second layer is a region 535 having an area that is substantially equal to or greater than the difference in area between the holes 515 in the first layer 510 and the holes 530 in the second layer 520. The region 535 is imprinted a pattern or color scheme, or both a pattern and color scheme to coordinate with printing on the first layer.

A retaining member such as a bow, ribbon, or clip is then passed through the holes 515, 530 in the first and second layers 510, 520 and secured in a desired manner. Advantageously, because the region 535 is imprinted with a pattern and/or color scheme that coordinates with that of the first layer 510, the presence of the holes in the first layer are concealed. In this way, the viewer of the finished article of social stationery can appreciate the presence of the retaining member without being distracted by the holes 515.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A method for producing an article, comprising the steps of:
a) defining a characteristic of at least one layer of the article;
b) displaying an image associated with the at least one layer to permit reviewing of the defined characteristic of the at least one layer;
c) repeating steps (a) and (b) in response to a determination that modification of the defined characteristic is desired; and
e) assembling the article at least in part by applying the at least one layer to at least one component of the article.

2. The method of claim 1, wherein the article comprises an article of social stationery.

3. The method of claim 1, wherein the characteristic is associated with a surface design of the article.

4. The method of claim 1, wherein the at least one layer comprises ink having a pattern, and the at least one component comprises at least one sheet of a medium.

5. The method of claim 4, wherein the medium is selected from a group of media consisting of paper, card-stock, and transparencies.

6. The method of claim 1, wherein defining the characteristic comprises selecting at least one design element associated with the at least one layer.

7. The method of claim 6, wherein the at least one design element is associated with at least one of a color, a pattern, a texture, an image, a border, a scaling factor, and an orientation of a pattern.

8. The method of claim 6, wherein assembling the article comprises applying to the at least one component at least one material in a form associated with the at least one design element.

9. The method of claim 8, wherein the at least one material comprises ink.

10. The method of claim 1, wherein the article comprises at least two layers, and further comprising performing steps (a), (b) and (c) for each of the at least two layers of the article.

11. The method of claim 10, wherein the article is associated with at least two components, and assembling comprises applying one of the at least two layers to one of the at least two components, and applying a second one of the at least two layers to a second one of the at least two components.

12. The method of claim 10, wherein assembling comprises applying at least two of the at least two layers to one of the at least two components.

13. The method of claim 10, wherein assembling the article comprises arranging the at least two layers relative to each other in response to a user selection.

14. The method of claim 13, wherein arranging comprises selecting an order of the two or more layers.

15. The method of claim 14, wherein assembling further comprises selecting a knock-out portion of an overlapped one of the at least two layers.

16. The method of claim 14, wherein defining a characteristic comprises defining at least one crop mark.

17. The method of claim 1, wherein displaying the image comprises at least one of rendering the image on a display screen, and fabricating a sample associated with the layer.

18. An article production apparatus, comprising:
a computing system configured to implement an application comprising the steps of:
a) defining a characteristic of at least one layer of an article in response to a customer input;
b) displaying, to a customer, an image associated with the at least one layer to permit reviewing of the defined characteristic of the at least one layer; and
c) repeating steps (a) and (b) in response to a customer indication that modification of the defined characteristic is desired, and
a printer configured to print the at least one layer on at least one component of the article.

19. The apparatus of claim 18, wherein the article comprises an article of social stationery.

20. A method for assembling an article of social stationery, comprising:
providing a first component, of the article of social stationery, defining a hole through the first component;
providing a second component of the article of social stationery;
providing an overlay of the article of social stationery;
disposing the first component between the second component and the overlay; and
attaching the overlay to a portion of the second component exposed through the hole in the first component, wherein the overlay at least partially conceals the hole.

21. The method of 20, wherein the overlay comprises an adhesive-backed material, and attaching comprises attaching the overlay to the portion of the second component via the adhesive.

22. A method for assembling an article of social stationery, comprising:
providing a first component, of the article of social stationery, defining a hole through the first component;
providing at second component, of the article of social stationery, defining a second hole through the second component having a smaller area than an area of the first hole,
wherein the second component has a visible feature surrounding the second hole that matches a visible feature of the first layer surrounding the first hole; and
attaching the first component to the second component so that the first hole overlaps the second hole, and the visible features surrounding the first and second holes match to camouflage an appearance of the first hole.

23. The method of claim 22, wherein attaching comprises inserting a retaining member through the first and second holes.
